(19) United States
(12) Patent Application Publication
(10) Pub. No.: US 2019/0382571 A1
(43) Pub. Date: Dec. 19, 2019

(54) RUBBER COMPOSITION AND CONDUCTIVE ROLLER USING THE SAME

(71) Applicant: SUMITOMO RUBBER INDUSTRIES, LTD., Hyogo (JP)

(72) Inventor: DAIJIRO SUZUKI, Hyogo (JP)

(73) Assignee: SUMITOMO RUBBER INDUSTRIES, LTD., Hyogo (JP)

(21) Appl. No.: 16/403,622

(22) Filed: May 6, 2019

(30) Foreign Application Priority Data
Jun. 13, 2018 (JP) 2018-113031

(51) Int. Cl. C08L 23/16; G03G 15/08; F16C 13/00; C08K 3/04; C08L 9/02; C08L 9/06

(52) U.S. Cl. CPC C08L 23/16; G03G 15/0808; F16C 13/00; C08K 3/04; C08L 2205/03; C08L 9/06; F16C 2208/10; C08L 2205/025; C08L 9/02

(57) ABSTRACT

A rubber composition which is possible to form a conductive roller having a roller main body having a higher flexibility than in the current situation and having excellent image durability while maintaining the volume resistivity of a roller main body in a range suitable for a developing roller and the like. The rubber composition contains rubbers including 15 parts by mass or more of an EPDM having a Mooney viscosity ML₁₊₄ (100° C.) of 10 or less with respect to 100 parts by mass of the total amount of rubbers and a diene rubber, and less than 25 parts by mass of carbon black with respect to 100 parts by mass of the total amount of rubbers. A conductive roller has a roller main body constituted by the rubber composition.

### CROSS-REFERENCE TO RELATED APPLICATION

This application claims the priority of Japan patent application serial no. 2018-113031, filed on Jun. 13, 2018. The entirety of the above-mentioned patent application is hereby incorporated by reference herein and made a part of this specification.

### BACKGROUND

### Technical Field

The disclosure relates to a rubber composition and a conductive roller having a roller main body formed using the rubber composition.

### Description of Related Art

For example, in image forming devices using electrophotography such as laser printers, electrostatic copying machines, plain paper facsimile machines, and a multifunctional machine thereof, developing rollers are used to develop an electrostatic latent image formed on the surface of a photoreceptor into a toner image.

In development using a developing roller, while a tip of a quantity regulating blade (charging blade) is in contact with the outer circumferential surface of the roller main body within a developing unit in which a toner is accommodated of the image forming device, the developing roller is rotated.

Then, the toner is charged and adheres to the outer circumferential surface of the roller main body, and an adhesion amount thereof is regulated when passing through a nip part between the outer circumferential surface of the roller main body and the tip of the quantity regulating blade, and thereby a toner layer is formed on the outer circumferential surface.

In addition, concurrently, the surface of the photoreceptor is uniformly changed and then exposed, and thereby an electrostatic latent image is formed.

Next, when the developing roller is additionally rotated in this state, the toner layer is transported to the vicinity of the surface of the photoreceptor.

Then, the toner forming the toner layer is selectively moved to the surface of the photoreceptor according to an electrostatic latent image formed on the surface of the photoreceptor, and the electrostatic latent image is developed into a toner image.

As the developing roller, a conductive roller having a roller main body which is formed by molding a rubber composition into a cylindrical shape and performing crosslinking and to which conductivity is imparted and a shaft which is made of a metal or the like and is inserted and fixed to a through-hole at the center of the roller main body is used.

In order to impart conductivity to the roller main body of the conductive roller, an ion-conducting rubber such as an epichlorohydrin rubber is used as a rubber forming the roller main body.

When ion conductivity is imparted to the roller main body using an ion-conducting rubber, the volume resistivity of the roller main body can be adjusted to, for example, a range suitable for the developing roller and the like.

Regarding the ion-conducting rubber, for example, generally an ethylene propylene diene rubber (EPDM) and/or diene rubber are used in combination.

Among these, the EPDM has excellent lightfastness, ozone resistance, weatherability, and the like. Therefore, when the EPDM is used together with an ion-conducting rubber, it is possible to improve such characteristics of the roller main body.

In addition, when a diene rubber is used in combination, it is possible for the rubber to impart favorable characteristics to the roller main body, that is, characteristics in which it is flexible, a compression set is small, and deformation is unlikely to occur.

Regarding the diene rubber, for example, acrylonitrile butadiene rubber (NBR) and styrene butadiene rubber (SBR) are used.

However, the conductive roller to which ion conductivity is imparted using an ion-conducting rubber has problems such as having a conductivity highly dependent on the environment, the high cost of an ion-conducting rubber, and difficulty in reducing costs of the conductive roller.

The EPDM and/or diene rubber may be used as a rubber, and a conductive agent having electron conductivity such as carbon black may be added to form an electron-conducting formulation that does not contain (excludes) an ion-conducting rubber.

However, in the case of an electron-conducting formulation, there are problems that the flexibility of the roller main body of the conductive roller may deteriorate, the roller main body may become hard, and the image durability may decrease.

The image durability is an index indicating how long a favorable image quality can be maintained in formed images by minimizing deterioration of the toner when the same toner is repeatedly used for image formation.

That is, in one image formation, only a small part of the toner accommodated in the developing unit of the image forming device is used, and the remaining larger part of the toner repeatedly circulates in the developing unit.

Therefore, an important key for improving the image durability is the extent to which the roller main body of the developing roller that repeatedly comes in contact with the toner provided in the developing unit damages the toner or does not damage the toner.

When the flexibility of the roller main body deteriorates and the image durability decreases, the image quality of the formed images tends to gradually deteriorate when image formation is repeated.

Therefore, in order to improve the image durability, particularly, a roller main body having excellent flexibility is required for a conductive roller used as a developing roller.

Therefore, various research regarding a rubber such as an EPDM and a diene rubber, carbon black, or types and proportions of crosslinking components for crosslinking the rubber and the like have been conducted (refer to Patent Documents 1 and 2 and the like).
[Patent Document 1] Japanese Patent Laid-Open No. 2015-212728
[Patent Document 2] Japanese Patent Laid-Open No. 2016-060802

Incidentally, according to studies performed by the inventors, in the disclosures described in Patent Documents 1 and 2, effects of increasing the flexibility of a roller main body and improving the image durability while the volume resistivity of a roller main body is maintained in a range suitable for a developing roller and the like are still insufficient, and further improvement is necessary.

The disclosure provides a rubber composition which is an electron-conducting formulation that does not include (excludes) an ion-conducting rubber and by which it is possible to form a conductive roller having a roller main body having a higher flexibility than in the current situation and having excellent image durability while maintaining the volume resistivity of a roller main body in a range suitable for a developing roller and the like, and which forms the roller main body.

In addition, the disclosure provides a conductive roller having a roller main body constituted by the rubber composition.

### SUMMARY

According to an embodiment of the disclosure, a rubber composition which includes a rubber and carbon black and is used to form a roller main body of a conductive roller is provided, wherein the rubber includes an EPDM having a Mooney viscosity ML₁₊₄ (100° C.) of 10 or less and a diene rubber, wherein a proportion of the EPDM is 15 parts by mass or more with respect to 100 parts by mass of the total amount of the rubber, and a proportion of the carbon black is less than 25 parts by mass with respect to 100 parts by mass of the total amount of the rubber.

In addition, according to an embodiment of the disclosure, there is provided a conductive roller having a roller main body constituted by the rubber composition.

### BRIEF DESCRIPTION OF THE DRAWINGS

FIG. 1 is a perspective view showing an example of a conductive roller according to an embodiment of the disclosure.

### DESCRIPTION OF THE EMBODIMENTS

According to the disclosure, it is possible to provide a rubber composition which is an electron-conducting formulation that does not contain an ion-conducting rubber, and by which it is possible to form a conductive roller having a roller main body having a higher flexibility than in the current situation and having excellent image durability while maintaining the volume resistivity of a roller main body in a range suitable for a developing roller and the like, and which forms the roller main body.

In addition, according to the disclosure, it is possible to provide a conductive roller having a roller main body constituted by the rubber composition.

<<Rubber Composition>>

As described above, the disclosure relates to a rubber composition which includes a rubber and carbon black and is used to form a roller main body of a conductive roller, wherein the rubber includes an EPDM having a Mooney viscosity ML₁₊₄ (100° C.) of 10 or less and a diene rubber, the proportion of the EPDM is 15 parts by mass or more with respect to 100 parts by mass of the total amount of rubbers, and the proportion of the carbon black is less than 25 parts by mass with respect to 100 parts by mass of the total amount of rubbers.

According to studies performed by the inventors, when an EPDM having a Mooney viscosity ML₁₊₄ (100° C.) of 10 or less is used in the above proportion in the rubber, it is possible to improve dispersibility of carbon black with respect to the rubber composition.

Therefore, even if the proportion of the carbon black is controlled such that it is within the above range, a volume resistivity of the roller main body constituted by the rubber composition can be set to a range suitable for the developing roller and the like.

In addition, when the proportion of the carbon black is reduced to the above range, it is possible to improve image durability of the conductive roller by imparting a high flexibility to the roller main body in combination with use of a diene rubber.

Therefore, according to the rubber composition of the disclosure, there is provided a rubber composition which is an electron-conducting formulation that does not contain an ion-conducting rubber, and by which it is possible to form a conductive roller having a roller main body having a higher flexibility than in the current situation and having excellent image durability while maintaining the volume resistivity of a roller main body in a range suitable for a developing roller and the like.

Here, it is described in Patent Document 2 that an EPDM having a Mooney viscosity ML₁₊₄ (100° C.) of 50 or less is preferably used, and as an example, an EPDM having a Mooney viscosity ML₁₊₄ (100° C.) of 10 or less is described.

However, an EPDM of which effects were actually verified in the example in Patent Document 2 was only Esprene (registered trademark, commercially available from Sumitomo Chemical Co., Ltd.) 505A having a Mooney viscosity ML₁₊₄ (100° C.) of 47 exceeding 10.

In addition, in the Example in Patent Document 2, carbon black was added in a proportion of 25 parts by mass with respect to 100 parts by mass of rubbers including the EPDM.

Incidentally, as described above, or as clearly understood from the results of Comparative Example 4 to be described below, in such a blend system, the roller main body becomes hard and the image durability of the conductive roller decreases.

Moreover, in Patent Document 2, there is no description of the relationship between the Mooney viscosity of the EPDM and dispersibility of carbon black, the above effects specific to the disclosure resulting therefrom, or the like.

Therefore, description regarding the EPDM in Patent Document 2 does not demonstrate or suggest the disclosure.

<Rubber>

Regarding the rubber, an EPDM having a Mooney viscosity ML₁₊₄ (100° C.) of 10 or less and at least a diene rubber are used in combination.

Particularly, it is preferable to use only two types of EPDMs having a Mooney viscosity ML₁₊₄ (100° C.) of 10 or less and a diene rubber (including a case in which two or more types of EPDMs having a Mooney viscosity ML₁₊₄ (100° C.) of 10 or less and two or more types of diene rubbers are used in combination, the same hereinafter) in combination.

Regarding the rubber, when an EPDM having a Mooney viscosity ML₁₊₄ (100° C.) of 10 or less and a diene rubber are used in combination, as described above, it is possible for the rubber to impart favorable characteristics to the roller main body.

### (EPDM)

Regarding the EPDM, among various EPDMs into which a double bond is introduced into a main chain by adding a small amount of a third component (diene) to ethylene and propylene, as described above, an EPDM having a Mooney viscosity ML₁₊₄ (100° C.) of 10 or less is selected and used.

The reason for this is the same as described above.

That is, when an EPDM having a Mooney viscosity ML₁₊₄ (100° C.) of greater than 10 is used, an effect of improving dispersibility of carbon black with respect to the rubber composition is not obtained.

Therefore, when an amount of carbon black is less than 25 parts by mass with respect to 100 parts by mass of the total amount of rubbers, the volume resistivity of the roller main body cannot be set to a range suitable for the developing roller and the like.

In order to make the volume resistivity of the roller main body constituted by the rubber composition be within a range suitable for the developing roller and the like, a large amount of carbon black exceeding a range of less than 25 parts by mass with respect to 100 parts by mass of the total amount of rubbers needs to be added.

Then, as a result, the roller main body becomes hard, and the image durability of the conductive roller decreases.

On the other hand, when an EPDM having a Mooney viscosity ML₁₊₄ (100° C.) 10 of or less is selected and used, it is possible to improve dispersibility of carbon black with respect to the rubber composition.

Therefore, the proportion of the carbon black necessary for making the volume resistivity of the roller main body be within a range suitable for the developing roller and the like can be minimized to less than 25 parts by mass with respect to 100 parts by mass of the total amount of rubbers.

Therefore, it is possible to improve image durability of the conductive roller by imparting favorable flexibility to the roller main body in combination with use of a diene rubber.

Here, regarding the EPDM, there are an oil-extended type in which an extender oil is added to adjust the flexibility and a non-oil-extended type in which no extender oil is added. In the disclosure, in order to prevent contamination of the photoreceptor and the like, a non-oil-extended type EPDM not containing an extender oil which may serve as a bleeding material is preferably used.

Regarding the non-oil-extended type EPDM having a Mooney viscosity ML₁₊₄ (100° C.) of 10 or less, for example, Mitsui EPT X-4010M (commercially available from Mitsui Chemicals) [Mooney viscosity ML₁₊₄ (100° C.): 8, content of ethylene: 54%, content of diene: 7.6%, non-oil extended] exemplified in Patent Document 2 can be selected and used, but the disclosure is not limited thereto.

The proportion of the EPDM having a Mooney viscosity ML₁₊₄ (100° C.) of 10 or less is limited to 15 parts by mass or more with respect to 100 parts by mass of the total amount of rubbers. The reason for this is as follows.

That is, when the EPDM having a Mooney viscosity ML₁₊₄ (100° C.) of 10 or less is not included, that is, the proportion of the EPDM is 0 parts by mass, an effect of improving dispersibility of carbon black with respect to the rubber composition resulting from addition of the EPDM is not obtained.

Therefore, in order to make the volume resistivity of the roller main body be within a range suitable for the developing roller and the like, a large amount of carbon black exceeding a range of less than 25 parts by mass with respect to 100 parts by mass of the total amount of rubbers needs to be added.

Then, as a result, the roller main body becomes hard and the image durability of the conductive roller decreases.

In addition, as described above, the EPDM has effects of improving lightfastness, ozone resistance, weatherability and the like of the roller main body. However, when no EPDM is added, such effects are not obtained. Therefore, the lightfastness, ozone resistance, weatherability, and the like of the roller main body also deteriorate.

On the other hand, even when a small amount of an EPDM having a Mooney viscosity ML₁₊₄ (100° C.) of 10 or less is added in a range of less than 15 parts by mass with respect to 100 parts by mass of the total amount of rubbers, it is possible to improve dispersibility of carbon black with respect to the rubber composition.

Accordingly, the proportion of the carbon black necessary for making the volume resistivity of the roller main body be within a range suitable for the developing roller and the like is minimized to less than 25 parts by mass with respect to 100 parts by mass of the total amount of rubbers, and thus it is possible to improve the image durability of the conductive roller.

However, when the proportion of the EPDM is less than 15 parts by mass with respect to 100 parts by mass of the total amount of rubbers, sufficient effects of improving lightfastness, ozone resistance, weatherability, and the like of the roller main body resulting from addition of the EPDM are still not obtained.

Therefore, the lightfastness, ozone resistance, weatherability, and the like of the roller main body deteriorate.

On the other hand, when the proportion of the EPDM having a Mooney viscosity ML₁₊₄ (100° C.) of 10 or less is 15 parts by mass or more with respect to 100 parts by mass of the total amount of rubbers, it is possible to improve the lightfastness, ozone resistance, weatherability, and the like of the roller main body.

In addition, dispersibility of carbon black with respect to the rubber composition is improved and the proportion of the carbon black necessary for making the volume resistivity of the roller main body be within a range suitable for the developing roller and the like can be minimized to less than 25 parts by mass with respect to 100 parts by mass of the total amount of rubbers.

Therefore, in combination with use of a diene rubber, favorable flexibility can be imparted to the roller main body and it is possible to improve image durability of the conductive roller.

Here, the proportion of the EPDM having a Mooney viscosity ML₁₊₄ (100° C.) of 10 or less is preferably 60 parts by mass or less within the above range with respect to 100 parts by mass of the total amount of rubbers.

When the proportion of the EPDM having a Mooney viscosity ML₁₊₄ (100° C.) of 10 or less exceeds the above range, the proportion of the diene rubber relatively decreases.

Therefore, when the diene rubber is used in combination, such an effect for the rubber to impart favorable characteristics to the roller main body described above may not be obtained sufficiently.

On the other hand, when the proportion of the EPDM having a Mooney viscosity ML₁₊₄ (100° C.) of 10 or less is set to be within the above range, it is possible for the rubber to impart favorable characteristics to the roller main body while maintaining favorable dispersibility of carbon black with respect to the rubber composition.

Therefore, the proportion of the carbon black can be reduced to be less than 25 parts by mass with respect to 100 parts by mass of the total amount of rubbers, and it is possible to impart favorable flexibility to the roller main body and improve image durability of the conductive roller.

(Diene Rubber)

Examples of the diene rubber used in combination with an EPDM having a Mooney viscosity ML₁₊₄ (100° C.) of 10 or less include a natural rubber, an isoprene rubber (IR), an acrylonitrile butadiene rubber (NBR), a styrene butadiene rubber (SBR), a butadiene rubber (BR), and a chloroprene rubber (CR).

Particularly, regarding the diene rubber, NBR and/or SBR are preferable.

NBR

Regarding the NBR, any of low nitrile NBR having an acrylonitrile content of 24% or less, medium nitrile NBR having an acrylonitrile content of 25 to 30%, medium to high nitrile NBR having an acrylonitrile content of 31 to 35%, high nitrile NBR having an acrylonitrile content of 36 to 42%, and extremely high nitrile NBR having an acrylonitrile content of 43% or more can be used.

Particularly, low nitrile to medium nitrile NBRs which are low to medium Mooney viscosity NBRs having a Mooney viscosity ML₁₊₄ (100° C.) of 65 or less are preferable. In addition, regarding the NBRs, there are an oil-extended type in which an extender oil is added to adjust the flexibility and a non-oil-extended type in which no extender oil is added. In the disclosure, in order to prevent contamination of the photoreceptor and the like, NBR of a non-oil-extended type not containing an extender oil which may serve as a bleeding material is preferably used.

As a preferable NBR that satisfies such conditions, for example, one, two, or more types of the following various NBRs can be used.

JSR (registered trademark) N250SL [low nitrile NBR, content of nitrile: 19.5%, Mooney viscosity ML₁₊₄ (100° C.): 43, non-oil extended], N250S [low nitrile NBR, content of nitrile: 19.5%, Mooney viscosity ML₁₊₄ (100° C.): 63, non-oil extended], N260S [low nitrile NBR, content of nitrile: 15%, Mooney viscosity ML₁₊₄ (100° C.): 62, non-oil extended], N240S [medium nitrile NBR, content of nitrile: 26%, Mooney viscosity ML₁₊₄ (100° C.): 56, non-oil extended], N241 [medium nitrile NBR, content of nitrile: 29%, Mooney viscosity ML₁₊₄ (100° C.): 56, non-oil extended], N242S [medium nitrile NBR, content of nitrile: 29%, Mooney viscosity ML₁₊₄ (100° C.): 56, non-oil extended] which are commercially available from JSR.

SBR

Regarding the SBR, any of various SBRs which are synthesized by copolymerizing styrene and 1,3-butadiene according to various polymerization methods such as an emulsion polymerization method and a solution polymerization method can be used.

In addition, regarding the SBRs, there are high styrene type, medium styrene type, and low styrene type SBRs classified according to a content of styrene, and any of them can be used.

Particularly, an SBR having a Mooney viscosity ML₁₊₄ (100° C.) of 60 or less is preferable.

In addition, as SBR, there are an oil-extended type in which an extender oil is added to adjust the flexibility and a non-oil-extended type in which no extender oil is added. In the disclosure, in order to prevent contamination of the photoreceptor and the like, SBR of a non-oil-extended type not containing an extender oil which may serve as a bleeding material is preferably used.

As a preferable SBR that satisfies such conditions, for example, one, two, or more types of the following various SBRs can be used.

JSR 1500 [content of styrene: 23.5%, Mooney viscosity ML₁₊₄ (100° C.): 52, non-oil extended], 1502 [content of styrene: 23.5%, Mooney viscosity ML₁₊₄ (100° C.): 52, non-oil extended], 1507 [content of styrene: 23.5%, Mooney viscosity ML₁₊₄ (100° C.): 35, non-oil extended] which are commercially available from JSR.

Regarding the rubber, the proportion of the diene rubber is the amount remaining after the EPDM when only two types of EPDMs having a Mooney viscosity ML₁₊₄ (100° C.) of 10 or less and a diene rubber are used in combination.

That is, the proportion of the diene rubber may be set so that the total amount of rubbers becomes 100 parts by mass when the proportion of the EPDM having a Mooney viscosity ML₁₊₄ (100° C.) of 10 or less is set to predetermined values within the above range.

<Carbon Black>

Regarding the carbon black, various types of carbon black having electron conductivity can be used.

Regarding the carbon black having electron conductivity, for example, one, two, or more types of Denka Black (registered trademark, commercially available from Denka Co., Ltd.) Ketchen black (registered trademark, commercially available from Lion), and carbon black SAF, ISAF, HAF can be used.

The proportion of the carbon black is limited to less than 25 parts by mass with respect to 100 parts by mass of the total amount of rubbers. The reason for this is as described above.

That is, when the proportion of the carbon black exceeds the above range, the roller main body becomes hard, and image durability of the conductive roller decreases.

On the other hand, when the proportion of the carbon black is set to be within the above range, a high flexibility is imparted to the roller main body in combination with use of a diene rubber as rubbers, and it is possible to improve image durability of the conductive roller.

Moreover, in the disclosure, when the EPDM having a Mooney viscosity ML₁₊₄ (100° C.) of 10 or less is used, as described above, it is possible to improve dispersibility of carbon black.

Therefore, even if the proportion of the carbon black is within the above range, the volume resistivity of the roller main body can be maintained in a range suitable for the developing roller and the like.

Here, in order to further improve such effects, in the above range, the proportion of the carbon black is preferably 15 parts by mass or more, particularly 18 parts by mass or more, and preferably 24 parts by mass or less with respect to 100 parts by mass of the total amount of rubbers.

### <Crosslinking Component>

A crosslinking component for crosslinking rubber is added to the rubber composition.

Regarding the crosslinking component, a crosslinking agent for crosslinking rubbers and a crosslinking promoter for promoting crosslinking of rubbers using the crosslinking agent are preferably used in combination.

Among these, regarding the crosslinking agent, for example, a sulfur-based crosslinking agent, a thiourea-based crosslinking agent, a triazine derivative-based crosslinking agent, a peroxide-based crosslinking agent, various monomers, and the like may be used. Particularly, a sulfur-based crosslinking agent is preferable.

### (Sulfur-Based Crosslinking Agent)

Examples of the sulfur-based crosslinking agent include sulfurs such as sulfur powder, oil-treated sulfur powder, precipitated sulfur, colloidal sulfur, and dispersible sulfur and an organic-sulfur-containing compound such as tetramethylthiuram disulfide and N,N-dithiobismorpholine. Particularly, sulfur is preferable.

In order for the rubber to impart favorable characteristics described above to the roller main body, the proportion of sulfur is preferably 0.3 parts by mass or more and preferably 2 parts by mass or less with respect to 100 parts by mass of the total amount of rubbers.

Here, for example, when oil-treated sulfur powder, dispersible sulfur, or the like is used as sulfur, the proportion is a proportion of sulfur itself as an active component contained therein.

In addition, when an organic-sulfur-containing compound is used as the crosslinking agent, the proportion is preferably adjusted so that the proportion of sulfur contained in molecules with respect to 100 parts by mass of the total amount of rubbers is within the above range.

(Crosslinking Promoter)

Examples of a crosslinking promoter for promoting crosslinking of rubbers using a sulfur-based crosslinking agent include one, two, or more types of a thiazole-based promoter, a thiuram-based promoter, a sulfenamide-based promoter, and a dithiocarbamate-based promoter.

Among these, a combination of a thiuram-based promoter and a thiazole-based promoter is preferably used.

Examples of the thiuram-based promoter include one, two, or more types of tetramethylthiuram monosulfide, tetramethylthiuram disulfide, tetraethylthiuram disulfide, tetrabutylthiuram disulfide, and dipentamethylene thiuram tetrasulfide.

In addition, examples of the thiazole-based promoter include one, two, or more types of 2-mercaptobenzothiazole, di-2-benzothiazolyl disulfide, a zinc salt of 2-mercaptobenzothiazole, a cyclohexylamine salt of 2-mercaptobenzothiazole, and 2-(4′-morpholinodithio)benzothiazole.

In a system using the above two types of crosslinking promoter in combination, in order to exhibit such an effect of promoting crosslinking of rubbers using a sulfur-based crosslinking agent sufficiently, the proportion of the thiuram-based promoter is preferably 0.3 parts by mass or more and 3 parts by mass or less with respect to 100 parts by mass of the total amount of rubbers.

In addition, the proportion of the thiazole-based promoter is preferably 0.3 parts by mass or more and 2 parts by mass or less with respect to 100 parts by mass of the total amount of rubbers.

<Others>

Various additives may be additionally added to the rubber composition as necessary.

Examples of the additive include a crosslinking aid, a plasticizer, and a processing aid.

Among these, examples of the crosslinking aid include one, two, or more types of metal compounds such as zinc oxide (zinc white); fatty acids such as stearic acid, oleic acid, and cotton seed fatty acid, and a crosslinking aid known in the related art.

Individually, the proportion of the crosslinking aid is preferably 0.1 parts by mass or more and preferably 7 parts by mass or less with respect to 100 parts by mass of the total amount of rubbers.

Examples of the plasticizer include various plasticizers such as dibutyl phthalate, dioctyl phthalate, and tricresyl phosphate, and various waxes such as polar wax.

In addition, examples of the processing aid include fatty acid metal salts such as zinc stearate.

The proportion of the plasticizer and/or processing aid is preferably 3 parts by mass or less with respect to 100 parts by mass of the total amount of rubbers.

In addition, regarding the additive, various additives such as an acid acceptor, a deterioration inhibitor, a scorching inhibitor, a plasticizer, a lubricant, a pigment, an antistatic agent, a flame retardant, a neutralizing agent, a nucleating agent, and a co-crosslinking agent may be additionally added in an arbitrary proportion.

<<Conductive Roller>>

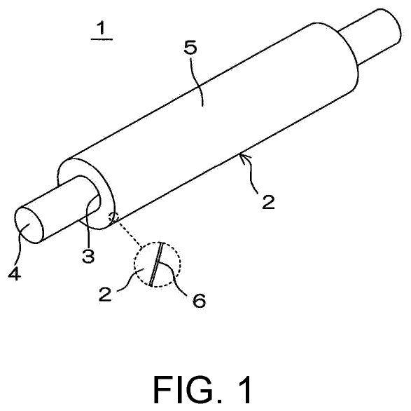

FIG. 1 is a perspective view showing an example of a conductive roller according to an embodiment of the disclosure.

Referring to FIG. 1, a conductive roller 1 of this example includes a roller main body 2 formed into a nonporous and single-layer cylindrical shape formed of the rubber composition containing the above components. A shaft 4 is inserted into and fixed to a through-hole 3 at the center of the roller main body 2.

The shaft 4 is integrally formed of a highly conductive material, for example, a metal such as iron, aluminum, an aluminum alloy, or stainless steel.

For example, the shaft 4 is electrically connected and mechanically fixed to the roller main body 2 using an adhesive having conductivity, or when a shaft having an outer diameter larger than the inner diameter of the through-hole 3 is press-fitted into the through-hole 3, it is electrically connected and mechanically fixed to the roller main body 2.

In addition, using both methods together, the shaft 4 may be electrically connected and mechanically fixed to the roller main body 2.

As shown in the enlarged part in the drawing, an oxide film 6 may be formed on an outer circumferential surface 5 of the roller main body 2.

When the oxide film 6 is formed, the oxide film 6 functions as a dielectric layer, and a dielectric loss tangent of the conductive roller 1 can be reduced.

In addition, when the oxide film 6 has a low-friction layer, for example, it is possible to minimize adhesion to the toner when used for a developing roller and the like.

Moreover, since the oxide film 6 can be easily formed, for example, by simply emitting ultraviolet rays in an oxidizing atmosphere, it is possible to minimize a decrease in the productivity of the conductive roller 1 and an increase in the production costs.

However, the oxide film 6 may not be formed.

Here, the “single-layer structure” of the roller main body 2 means that the number of layers made of a rubber or the like is one, and the oxide film 6 formed by emitting ultraviolet rays or the like is not included in the number of layers.

<Volume Resistivity of Roller Main Body>

The volume resistivity (Ω·cm) of the roller main body can be set to be within a range suitable for its application according to the application of the conductive roller.

For example, in the case of the developing roller, the volume resistivity (Ω·cm) in terms of a common logarithm value log Ω·cm is preferably 4.0 or more and preferably 8.5 or less.

When the volume resistivity of the roller main body is below the above range or exceeds the above range, in both cases, the volume resistivity is outside a range suitable for the developing roller, and it is not possible to develop a favorable image without image defects according to the mechanism described above.

For example, when the volume resistivity is below the above range, image defects may occur in the formed images due to an overcurrent.

In addition, when the volume resistivity exceeds the above range, image defects such as a decrease in the image density of the formed images and fogging in the margin part of the formed images may occur.

On the other hand, when the volume resistivity of the roller main body is set to be within the above range, a favorable image without image defects can be formed when the conductive roller is used as a developing roller.

Here, in the disclosure, the volume resistivity of the roller main body is expressed by a value measured according to a measurement method described in the Japanese Industrial Standards JIS K6271-1:2015 “Vulcanized rubber and thermoplastic rubber-Determination of electrical resistivity-Part 1: double ring electrode method” under an environment with a temperature of 23±1° C. and a relative humidity of 55±1%.

That is, a rubber composition with the same composition as that forms the roller main body is molded into a sheet form and crosslinked to produce a sheet-like test piece according to the above standards of JIS, and, and a value measured using the produced test piece when an applied voltage is set to 100 V is obtained as a volume resistivity of the roller main body.

<Rubber Hardness of Roller Main Body>

In the case of the developing roller, the rubber hardness of the roller main body is preferably 40° or more, particularly 43° or more, and preferably less than 50°, particularly 48° or less in terms of the type A durometer hardness.

When the type A durometer hardness is below the above range, the strength of the roller main body 2 is insufficient and deformation and the like are likely to occur in some cases.

On the other hand, when the type A durometer hardness exceeds the above range, the roller main body 2 may then become too hard and the image durability may decrease.

The type A durometer hardness of the roller main body is expressed by a value measured according to the following measurement method using a type A durometer according to the Japanese Industrial Standards JIS K6253-3: 2012 “Vulcanized rubber and thermoplastic rubber-Determination of hardness—Part 3: Durometer hardness” under an environment with a temperature of 23±2° C. and a relative humidity of 55±2%.

That is, while both ends of a shaft protruding from both ends of the roller main body is fixed to a support table, a push needle of the type A durometer is brought into contact with the center of the roller main body in the width direction from above, and a type A durometer hardness is obtained under conditions of a mass applied to the pressurized surface: 1 kg, and a measurement time: 3 seconds (standard measurement time for vulcanized rubber).

<Production of Conductive Roller>

In order to produce the conductive roller 1, first, the rubber composition containing the above-described components is extruded and molded into a cylindrical shape using an extrusion molding machine, then cut to a predetermined length, and pressurized with pressurized steam in a vulcanizer, heated and crosslinked.

Next, the crosslinked cylindrical component is heated using an oven or the like and subjected to secondary crosslinking and then cooled, and additionally polished so that it has a predetermined outer diameter, and thereby the roller main body 2 is formed.

The shaft 4 can be inserted into and fixed to the through-hole 3 at any time between after the cylindrical component is cut and after polishing.

However, after cutting, it is preferable to perform secondary crosslinking and polishing first while the shaft 4 is inserted into the through-hole 3.

Therefore, it is possible to minimize warping, deformation, and the like of the cylindrical component due to expansion and contraction during secondary crosslinking.

In addition, when polishing is performed while rotating around the shaft 4, it is possible to improve workability of the polishing and minimize deflection of an outer circumferential surface 5.

As described above, the shaft 4 is inserted into the through-hole 3 of the cylindrical component before secondary crosslinking using an adhesive having conductivity, and particularly, a conductive thermosetting adhesive, and then subjected to secondary crosslinking, or a shaft having an outer diameter larger than the inner diameter of the through-hole 3 may be press-fitted into the through-hole 3.

In the former case, a cylindrical component is subjected to secondary crosslinking due to heating in an oven and, and at the same time, a thermosetting adhesive is cured, and the shaft 4 is electrically connected and mechanically fixed to the roller main body 2.

In addition, in the latter case, press-fitting is performed, and at the same time, electrical connection and mechanical fixing are completed.

In addition, as described above, using both methods together, the shaft 4 may be electrically connected and mechanically fixed to the roller main body 2.

As described above, the oxide film 6 is preferably formed on the outer circumferential surface 5 of the roller main body 2 by emitting ultraviolet rays.

That is, when ultraviolet rays with a predetermined wavelength are emitted to the outer circumferential surface 5 of the roller main body 2 in an oxidizing atmosphere for a predetermined time, and a diene rubber in the rubber composition constituting the vicinity of the outer circumferential surface 5 is oxidized, the oxide film 6 can be formed.

Therefore, the process of forming the oxide film 6 is simple and efficient, and it is possible to minimize a decrease in the productivity of the conductive roller 1 and an increase in the production costs.

In addition, the oxide film 6 formed by emitting ultraviolet rays does not cause problems, for example, as in a coating film formed by applying a coating agent, and has excellent thickness uniformity and adhesion to the roller main body 2, and the like.

In order to oxidize a diene rubber in the rubber composition with high efficiency and form the oxide film 6 having excellent functions described above, the wavelength of ultraviolet rays emitted is preferably 100 nm or more and 400 nm or less, particularly preferably 300 nm or less.

In addition, the irradiation time is preferably 30 seconds or longer, particularly 1 minute or longer, and preferably 30 minutes or shorter, particularly 20 minutes or shorter.

However, the oxide film 6 may be formed by other methods and may not be formed.

In the embodiment in FIG. 1, the roller main body 2 has a single-layer structure formed of a crosslinked product of the rubber composition of the disclosure including the above components. However, the roller main body may have a structure in which two or more layers are laminated.

In this case, the outermost layer constituting the laminated structure may be formed of a crosslinked product of the rubber composition of the disclosure including the above components.

For example, in image forming devices using electrophotography such as a laser printer, an electrostatic copying machine, a plain paper facsimile machine, and a multifunctional machine thereof, the conductive roller of the disclosure can be suitably used as a developing roller.

In addition, the conductive roller can be used as, for example, a charging roller, a transfer roller, and a cleaning roller.

### EXAMPLES

The disclosure will be described below in detail based on examples and comparative examples. However, the configuration of the disclosure is not necessarily limited to these examples and comparative examples.

### Example 1

Regarding the rubber, 30 parts by mass of the EPDM having a Mooney viscosity ML₁₊₄ (100° C.) of 10 or less [Mitsui EPT X-4010M commercially available from Mitsui Chemicals described above, Mooney viscosity ML₁₊₄ (100° C.): 8, content of ethylene: 54%, content of diene: 7.6%, non-oil extended], and 70 parts by mass of NBR [JSR N250SL commercially available from JSR described above, low nitrile NBR, content of nitrile: 19.5%, Mooney viscosity ML₁₊₄ (100° C.): 43, non-oil extended] as a diene rubber were added.

Then, while masticating 100 parts by mass of the total amount of both rubbers using a Banbury mixer, first, components shown in the following Table 1 were added and kneaded.

TABLE 1

| Component | Parts by mass |
|---|---|
| Crosslinking aid | 2.5 |
| Carbon black | 21 |
| Processing aid | 0.5 |

The components in Table 1 are as follows. Here, the parts by mass in Table 1 are parts by mass with respect to 100 parts by mass of the total amount of rubbers.

Crosslinking aid: two types of zinc oxide [commercially available from Sakai Chemical Industry Co., Ltd.]

Carbon black: ISAF [Diablack (registered trademark, commercially available from Mitsui Chemicals) I]

Processing aid: zinc stearate [SZ-2000, commercially available from Sakai Chemical Industry Co., Ltd.]

Next, the following crosslinking components were added and kneading was additionally performed to prepare a rubber composition.

TABLE 2

| Crosslinking component | Parts by mass |
|---|---|
| Crosslinking agent | 0.5 |
| Promoter TS | 0.5 |
| Promoter DM | 1.5 |

Components in Table 2 are as follows. In addition, the parts by mass in the table are parts by mass with respect to 100 parts by mass of the total amount of rubbers.

Crosslinking agent: sulfur with 5% oil [commercially available from Tsurumi Chemical Industry Co., Ltd.]

Promoter TS: tetramethylthiuram monosulfide [Sanceler (registered trademark, commercially available from Sanshin Chemical Industry Co., Ltd.) TS, thiuram-based promoter]

Promoter DM: di-2-benzothiazolyl disulfide [Nocceler (registered trademark, commercially available from Ouchi Shinko Chemical Industry) DM]

(Conductive Roller)

The prepared rubber composition was supplied to an extrusion molding machine and extruded and molded into a cylindrical shape with an outer diameter of φ20.5 mm and an inner diameter of φ6.5 mm, then cut to a predetermined length, and attached to a temporary shaft for crosslinking.

Next, pressurization and heating were performed in a vulcanizer with pressurized steam at 160° C. for 1 hour to crosslink rubbers.

Next, the crosslinked cylindrical component was re-attached to a shaft having an outer circumferential surface to which a conductive thermosetting adhesive was applied and having an outer diameter of φ7.5 mm, heated in an oven at 160°, and subjected to secondary crosslinking, and electrically connected and mechanically fixed to the shaft by curing the thermosetting adhesive.

Then, both ends of the cylindrical component was shaped, the outer circumferential surface was then subjected to traverse grinding using a cylindrical grinding machine, and next subjected to mirror-polishing as finish polishing and thus finishing was performed so that the outer diameter was φ20.00 mm (tolerance±0.05 mm).

Then, the outer circumferential surface after polishing was wiped with an alcohol, and was then set in an UV treatment device, and ultraviolet rays were emitted during rotating, an oxide film was formed on the outer circumferential surface, a roller main body was formed, and thereby a conductive roller was produced.

### Example 2

A rubber composition was prepared in the same manner as in Example 1 except that, as a diene rubber, the same amount of SBR [JSR 1502 commercially available from JSR described above, content of styrene: 23.5%, Mooney viscosity ML₁₊₄ (100° C.): 52, non-oil extended] was added to produce a conductive roller.

### Example 3

A rubber composition was prepared in the same manner as in Example 1 except that, as a diene rubber, 40 parts by mass of the same NBR as used in Example 1 and 30 parts by mass of the same SBR as used in Example 2 were used together to produce a conductive roller.

### Example 4

A rubber composition was prepared in the same manner as in Example 1 except that, as carbon black, 24 parts by mass of HAF [Seast (registered trademark) 3 commercially available from Tokai Carbon Co., Ltd.] with respect to 100 parts by mass of the total amount of rubbers was added to produce a conductive roller.

### Comparative Example 1

A rubber composition was prepared in the same manner as in Example 1 except that, as an EPDM, the same amount of Mitsui EPT 4021 commercially available from Mitsui Chemicals [Mooney viscosity ML₁₊₄ (100° C.): 24, content of ethylene: 51%, content of diene: 8.1%, non-oil extended] having a Mooney viscosity ML₁₊₄ (100° C.) of 24 was added to produce a conductive roller.

### Comparative Example 2

A rubber composition was prepared in the same manner as in Example 1 except that, as an EPDM, the same amount of Mitsui EPT 8030M commercially available from Mitsui Chemicals [Mooney viscosity ML₁₊₄ (100° C.): 32, content of ethylene: 47%, content of diene: 9.5%, non-oil extended] having a Mooney viscosity ML₁₊₄ (100° C.) of 32 was added to produce a conductive roller.

### Comparative Example 3

A rubber composition was prepared in the same manner as in Example 1 except that, as an EPDM, the same amount of Esprene (registered trademark) 505A commercially available from Sumitomo Chemical Co., Ltd. ([Mooney viscosity ML₁₊₄ (100° C.): 47, content of ethylene: 50%, content of diene: 9.5%, non-oil extended] having a Mooney viscosity ML₁₊₄ (100° C.) of 47 was added to produce a conductive roller.

### Comparative Example 4

A rubber composition was prepared in the same manner as in Comparative Example 3 except that an amount of carbon black with respect to 100 parts by mass of the total amount of rubbers was 25 parts by mass to produce a conductive roller.

This was a reproduction of the example in Patent Document 2.

### Comparative Example 5

A rubber composition was prepared in the same manner as in Comparative Example 3 except that an amount of the EPDM was 100 parts by mass, no NBR was added, and an amount of carbon black with respect to 100 parts by mass of the total amount of rubbers was 30 parts by mass to produce a conductive roller.

### Comparative Example 6

A rubber composition was prepared in the same manner as in Example 1 except that an amount of the EPDM was 100 parts by mass, no NBR was added, and an amount of carbon black with respect to 100 parts by mass of the total amount of rubbers was 30 parts by mass to produce a conductive roller.

### Comparative Example 7

A rubber composition was prepared in the same manner as in Example 1 except that an amount of NBR was 100 parts by mass, no EPDM was added, and an amount of carbon black with respect to 100 parts by mass of the total amount of rubbers was 30 parts by mass to produce a conductive roller.

### Example 5

A rubber composition was prepared in the same manner as in Example 1 except that an amount of the EPDM was 20 parts by mass, and an amount of NBR was 80 parts by mass to produce a conductive roller.

### Example 6

A rubber composition was prepared in the same manner as in Example 1 except that an amount of the EPDM was 15 parts by mass, and an amount of NBR was 85 parts by mass to produce a conductive roller.

### Example 7

A rubber composition was prepared in the same manner as in Example 1 except that an amount of the EPDM was 60 parts by mass, and an amount of NBR was 40 parts by mass to produce a conductive roller.

### Comparative Example 8

A rubber composition was prepared in the same manner as in Example 1 except that an amount of the EPDM was 10 parts by mass, and an amount of NBR was 90 parts by mass to produce a conductive roller.

<Measurement and Evaluation of Volume Resistivity>

The rubber compositions prepared in the examples and comparative examples were molded in a sheet form and crosslinked, and test pieces with 13 cm in length×13 cm in width×2 mm in thickness were produced in a sheet form according to standards of JIS K6271-1:2015 described above.

Next, using the produced test pieces, a volume resistivity (Ω·cm) under an environment with a temperature of 23±1° C. and a relative humidity of 55±1% in conditions of an applied voltage of 100 V was measured according to the measurement method described above.

Then, a common logarithm value log Ω·cm of the measured volume resistivity was obtained, and it was evaluated as favorable (0) when the common logarithm value log Ω·cm was 4.0 or more, 8.5 or less, and it was evaluated as poor (x) when the common logarithm value log Ω·cm was outside this range.

### <Measurement and Evaluation of Rubber Hardness>

The type A durometer hardness of the roller main body of the conductive rollers produced in the examples and the comparative examples was measured under an environment with a temperature of 23±2° C. and a relative humidity of 55±2% according to the measurement method described above.

Then, it was evaluated as favorable (0) when the type A durometer hardness was 40° or more and less than 50°, and it was evaluated as poor (x) when the type A durometer hardness was outside this range.

### <Evaluation of Initial Image Density>

A genuine developing roller of a laser printer [HL-L6400DW commercially available from Brother Industries, Ltd.] was replaced with the conductive rollers produced in the examples and the comparative examples, and images with a density of 1% were continuously formed on 30 sheets of plain paper under an environment with a temperature of 23.5° C. and a relative humidity of 55%, and then evaluation images were formed.

Then, the image density of the formed evaluation images was measured using a reflection densitometer (commercially available from Videojet X-Rite), and the image durability was evaluated according to the following criteria.

◯: The image density of the black solid part was 1.3 or more, and a 2-dot density was 0.02 or more. Favorable.
x: The image density of the black solid part was less than 1.3, and/or a 2-dot density was less than 0.02. Poor.

Here, when the initial image density was poor (x), the next image durability evaluation was not performed.

### <Evaluation of Image Durability>

A genuine developing roller of a laser printer [HL-L6400DW commercially available from Brother Industries, Ltd.] was replaced with the conductive rollers produced in the examples and the comparative examples, and images with a density of 1% were continuously formed on 3000 sheets of plain paper under an environment with a temperature of 23.5° C. and a relative humidity of 55%, and evaluation images were then formed.

Then, the image density of the formed evaluation images was measured using a reflection densitometer (commercially available from Videojet X-Rite), and the image durability was evaluated according to the following criteria.

◯: The image density of the black solid part was 1.3 or more, and a 2-dot density was 0.02 or more. Favorable.
x: The image density of the black solid part was less than 1.3, and/or a 2-dot density was less than 0.02. Poor.

<Evaluation of Lightfastness>

When ultraviolet rays were emitted when the conductive rollers of the examples and the comparative examples were produced, it was evaluated as favorable (0) if no cracks occurred on the outer circumferential surface, and it was evaluated as poor (x) if cracks occurred.

The above results are shown in Table 3 to Table 5.

TABLE 3

| | | | | | | | Comparative |
|---|---|---|---|---|---|---|---|
| | | | Example 1 | Example 2 | Example 3 | Example 4 | Example 1 |
| Component | EPDM | Mooney | 8 | 8 | 8 | 8 | 24 |
| | | viscosity | | | | | |
| | | [ML₁₊₄ | | | | | |
| | | (100° C.)] | | | | | |
| | | Parts by | 30 | 30 | 30 | 30 | 30 |
| | | mass | | | | | |
| | Diene | NBR | 70 | — | 40 | 70 | 70 |
| | rubber | SBR | — | 70 | 30 | — | — |
| | (parts by | | | | | | |
| | mass) | | | | | | |
| | Carbon | ISAF | 21 | 21 | 21 | — | 21 |
| | black | HAF | — | — | — | 24 | — |
| Evaluation | Volume | logΩ · cm | 7.7 | 7.5 | 7.6 | 7.7 | 9.3 |
| | resistivity | Evaluation | ◯ | ◯ | ◯ | ◯ | X |
| | Type A | Numerical | 46 | 47 | 47 | 47 | 47 |
| | durometer | value | | | | | |
| | | Evaluation | ◯ | ◯ | ◯ | ◯ | ◯ |

| | | | | | |
|---|---|---|---|---|---|
| Initial image density | ◯ | ◯ | ◯ | ◯ | X |
| Image durability | ◯ | ◯ | ◯ | ◯ | — |
| Lighfastness | ◯ | ◯ | ◯ | ◯ | ◯ |

TABLE 4

| | | | Comparative | Comparative | Comparative | Comparative | Comparative |
|---|---|---|---|---|---|---|---|
| | | | Example 2 | Example 3 | Example 4 | Example 5 | Example 6 |
| Component | EPDM | Mooney | 32 | 47 | 47 | 47 | 8 |
| | | viscosity | | | | | |
| | | [ML₁₊₄ | | | | | |
| | | (100° C.)] | | | | | |
| | | Parts by | 30 | 30 | 30 | 100 | 100 |
| | | mass | | | | | |
| | Diene | NBR | 70 | 70 | 70 | — | — |
| | rubber | SBR | — | — | — | — | — |
| | (parts by | | | | | | |
| | mass) | | | | | | |
| | Carbon | ISAF | 21 | 21 | 25 | 30 | 30 |
| | black | HAF | — | — | — | — | — |
| Evaluation | Volume | logΩ · cm | 9.2 | 9.3 | 7.5 | 8.3 | 8.2 |
| | resistivity | Evaluation | X | X | ◯ | ◯ | ◯ |
| | Type A | Numerical | 47 | 47 | 50 | 58 | 65 |
| | durometer | value | | | | | |
| | | Evaluation | ◯ | ◯ | X | X | X |

| | | | | | |
|---|---|---|---|---|---|
| Initial image density | X | X | ◯ | ◯ | ◯ |
| Image durability | — | — | X | X | X |
| Lighfastness | ◯ | ◯ | ◯ | ◯ | ◯ |

TABLE 5

| | | | | | | Comparative | Comparative |
|---|---|---|---|---|---|---|---|
| | | | Example 7 | Example 5 | Example 6 | Example 8 | Example 7 |
| Component | EPDM | Mooney | 8 | 8 | 8 | 8 | — |
| | | viscosity | | | | | |
| | | [ML₁₊₄ | | | | | |
| | | (100° C.)] | | | | | |
| | | Parts by | 60 | 20 | 15 | 10 | — |
| | | mass | | | | | |
| | Diene | NBR | 40 | 80 | 85 | 90 | 100 |
| | rubber | SBR | — | — | — | — | — |
| | (parts by | | | | | | |
| | mass) | | | | | | |
| | Carbon | ISAF | 21 | 21 | 21 | 21 | 30 |
| | black | HAF | — | — | — | — | — |
| Evaluation | Volume | logΩ · cm | 7.7 | 7.9 | 7.8 | 7.9 | 8.2 |
| | resistivity | Evaluation | ◯ | ◯ | ◯ | ◯ | ◯ |
| | Type A | Numerical | 44 | 46 | 46 | 46 | 56 |
| | durometer | value | | | | | |
| | | Evaluation | ◯ | ◯ | ◯ | ◯ | X |

| | | | | | |
|---|---|---|---|---|---|
| Initial image density | ◯ | ◯ | ◯ | ◯ | ◯ |
| Image durability | ◯ | ◯ | ◯ | ◯ | X |
| Lighfastness | ◯ | ◯ | ◯ | X | X |

Based on the results of Examples 1 to 7 and Comparative Examples 1 to 5 in Table 3 to Table 5, it was found that, when an EPDM having a Mooney viscosity ML₁₊₄ (100° C.) of 10 or less was used together with a diene rubber as rubbers, and the proportion of the carbon black was less than 25 parts by mass with respect to 100 parts by mass of the total amount of rubbers, while the volume resistivity of the roller main body was maintained in a range suitable for the developing roller, it was possible to form a conductive roller having a roller main body having a high flexibility and having excellent image durability.

However, based on the results of Examples 1, and 5 to 7, and Comparative Examples 6 to 8, it was found that, in order to obtain the above effects and improve lightfastness and the like of the roller main body, it was necessary for the proportion of the EPDM having a Mooney viscosity ML₁₊₄ (100° C.) of 10 or less to be 15 parts by mass or more with respect to 100 parts by mass of the total amount of rubbers and particularly preferably 60 parts by mass or less.

What is claimed is:

1. A rubber composition comprising a rubber and carbon black and is used to form a roller main body of a conductive roller,
wherein the rubber comprises an ethylene propylene diene rubber having a Mooney viscosity ML₁₊₄ (100° C.) of 10 or less and a diene rubber,
wherein a proportion of the ethylene propylene diene rubber is 15 parts by mass or more with respect to 100 parts by mass of the total amount of the rubber, and
wherein a proportion of the carbon black is less than 25 parts by mass with respect to 100 parts by mass of the total amount of the rubber.

2. The rubber composition according to claim 1,
wherein the proportion of the ethylene propylene diene rubber is 60 parts by mass or less with respect to 100 parts by mass of the total amount of the rubber.

3. The rubber composition according to claim 1,
wherein the proportion of the carbon black is 15 parts by mass or more and 24 parts by mass or less with respect to 100 parts by mass of the total amount of the rubber.

4. The rubber composition according to claim 1,
wherein the diene rubber is at least one selected from among the group consisting of an acrylonitrile butadiene rubber and a styrene butadiene rubber.

5. A conductive roller comprising a roller main body constituted by the rubber composition according to claim 1.

6. The conductive roller according to claim 5, used as a developing roller which is incorporated into an image forming device using electrophotography, and develops an electrostatic latent image formed on the surface of a photoreceptor into a toner image with a charged toner.

7. The rubber composition according to claim 2,
wherein the proportion of the carbon black is 15 parts by mass or more and 24 parts by mass or less with respect to 100 parts by mass of the total amount of the rubber.

8. The rubber composition according to claim 2,
wherein the diene rubber is at least one selected from among the group consisting of an acrylonitrile butadiene rubber and a styrene butadiene rubber.

9. The rubber composition according to claim 3,
wherein the diene rubber is at least one selected from among the group consisting of an acrylonitrile butadiene rubber and a styrene butadiene rubber.

10. A conductive roller comprising a roller main body constituted by the rubber composition according to claim 2.

11. A conductive roller comprising a roller main body constituted by the rubber composition according to claim 3.

12. A conductive roller comprising a roller main body constituted by the rubber composition according to claim 4.
